(19) United States
(12) Patent Application Publication
(10) Pub. No.: US 2004/0231808 A1
(43) Pub. Date: Nov. 25, 2004

(54) Folding grille assembly

(76) Inventor: Michael B. Belanger, Cornwall (CA)

Correspondence Address: JACK PAAVILA, BOX 1151, ALEXANDRIA, KOC IA0, CA

(21) Appl. No.: 10/440,878

(22) Filed: May 19, 2003

(51) Int. Cl. E05D 15/26

(52) U.S. Cl. 160/199

(57) ABSTRACT

A folding grille assembly to be used to close an opening in a narrow wall. The grill assembly has a pocket and a folding grille. The pocket is adapted to be mounted on one side of the opening aligned with the wall and forming part of the wall. The folding grille has a plurality of narrow, vertical, panels, the panels hingedly joined together in serial fashion by vertical hinges. Every second panel only carries a vertical mounting rod at its top end extending up from the top, center of the panel, and every second mounting rod only carries a trolley by means of which the grille can be movably supported at the top of the opening. The pocket forms a receptacle for the grille when the grille is folded to open the opening. The invention also covers the pocket and the folding grill.

### BACKGROUND OF THE INVENTION

1. Field of the Invention

This invention is directed to a folding grille assembly. The invention is more particularly directed toward a compact folding grille assembly that can be easily installed to close openings in narrow walls. The grille assembly is particularly suited for use in existing buildings having narrow interior walls with wide openings in the walls that could be closed by folding grilles. The invention is also directed toward a folding grille used in the grille assembly, and toward a pocket used in the grille assembly for receiving the folding grille in a folded position.

2. Description of the Related Art

To use folding grilles in narrow walls, the vertical panels in the grille must be narrow to fit within the narrow walls when the grille is stored in a folded position within the wall. If the panels are narrow however, the folded grille would normally take up more length since more panels are needed to close the opening when the panels are narrow than when the panels are wide. In addition, with each panel usually having a trolley to support it, and with there being more panels, the trolleys, normally being thicker than the panels they support, take up more room when the grille is folded further increasing the length of the folded grille. A grille having narrow vertical panels can also be hard to fold if the panels are allowed to closely approach a straight line between adjacent panels when the grille is unfolded. Therefore grilles using narrow panels should be limited in how much they can unfold with there being more of an angle between adjacent panels when the grille is unfolded than in a grille using wider panels. However, when limiting how much the panels can unfold, the grille must be lengthened thus increasing the folded length of the grille as well. Overall, the slot within the narrow wall to receive the folded grille must therefor be quite deep to receive the longer, folded, grille and this can make the installation of the grille in narrow walls, particularly a retrofit installation, expensive.

Known folding grille assemblies used in narrow walls also have pockets for receiving the grilles, the pocket mounted within a space or slot formed in the narrow wall on one side of the opening to be closed by the grille. The known pockets are usually quite cumbersome, limiting the width of the space available to receive the folded grille and requiring the grille to have even more narrow panels and/or narrower panels. A further problem is that the pockets are usually prefabricated and when inserted in the slot it may be difficult to level the pocket within the slot to properly receive the folded grille.

### SUMMARY OF THE INVENTION

It is the purpose of the present invention to provide a folding grille assembly that is designed to be used with narrow walls. More particularly, it is one purpose of the present invention to provide a folding grille with narrow panels that folds more compactly, in length, than known grilles so that it does not require a very long slot within the wall to receive it thus making installation easier and cheaper. It is another purpose of the present invention to provide a folding grille with narrow panels that is limited in the amount adjacent panels can unfold with respect to each other to make folding of the grille, from an unfolded position, easier. It is another purpose of the present invention to provide a pocket for a rolling grille assembly that is designed to provide the largest amount of space within a slot for the grille when the grille is located within the pocket. It is another purpose of the present invention to provide a pocket for a rolling grille assembly that can be leveled during installation.

In accordance with one aspect of the present invention, the folding grille is provided with narrow panels with every second panel having a flat top member. Every other second panel in the grille has a top member with a central, vertical, tubular section which section mounts a support rod for the grille. Since only every second panel has a top member with a tubular section, the panels can fold more tightly together than a grille having each panel with a top member with a tubular section. In addition, only every second one of the panels having a top member with a tubular section, has a support rod with a trolley mounted thereon for supporting the grille from a top rail. With one trolley for every four consecutive panels in the grille, the panels can be tightly folded together without the trolleys preventing this tight folding.

With narrow panels, the folding grille is harder to start to fold particularly if the angle between adjacent panels, when the grille is unfolded, is too great. In accordance with another aspect of the present invention, the narrow panels are provided with stop means limiting the unfolding of the panels to have a lesser angle between adjacent panels when the grille is unfolded. The angle between adjacent panels, as determined by the stop means, would not be greater than 140° thereby making it easier to start folding of the grille.

The grille assembly, in a further aspect of the present invention, also includes a narrow, open, pocket for receiving the narrow, folded grille. The pocket is provided by a set of at least four vertical tubes, the tubes arranged at the corners of a narrow rectangle space. First and second tubes form one wide side of the space, third and fourth tubes form the other wide side of the pocket, parallel to the one wide side. The second and third tubes form the narrow back of the pocket and the first and fourth tubes form the narrow front of the pocket. Top and bottom frame members at the top and bottom join the vertical tubes together. Additional cross members can be used to strengthen the pocket intermediate the top and bottom. The additional cross members extend across the wide sides and the narrow back of the pocket. The front of the pocket is open. Adjustment means can be provided at the bottoms of the tubes to adjust the height of the pocket and to level it. Connection means are also provided for simply and easily connecting the folding grille at one end to the back of the pocket to retain the one end of the grille within the pocket as the grille is unfolded from within the pocket to close an opening.

The invention is particularly directed toward a folding grille assembly for use in closing an opening in a narrow wall. The grill assembly has a pocket adapted to be mounted on one side of the opening aligned with the wall, the pocket forming part of the wall. The grille assembly has a folding grille; the grille having a plurality of narrow, vertical, panels, the panels hingedly joined together in serial fashion by vertical hinges, every second panel only carrying a vertical mounting rod at its top end extending up from the top, center of the panel, and every second mounting rod only carrying a trolley by means of which the grille can be movably supported at the top of the opening. The pocket forms a receptacle for the grille when the grille is folded to open the opening.

The invention is also particularly directed toward a folding grille having a plurality of narrow, vertical, panels, the panels hingedly joined together in serial fashion by vertical hinges. Every second panel only carries a vertical mounting rod at its top end extending up from the top, center of the panel, and every second mounting rod only carries a trolley by means of which the grille can be supported.

The invention is further particularly directed toward a pocket for use with a rolling grille for closing an opening in a wall, the pocket adapted to be mounted on side of the opening aligned with the wall and forming an extension of the wall. The pocket has four vertical square tubes located at the corners of the pocket and connecting members at the top and bottom of the tubes to connect the tubes into a rigid structure, the tubes enclosing a narrow space having a rectangular cross-section. The connecting members are located within the space defined by the tubes.

### BRIEF DESCRIPTION OF THE DRAWINGS

FIG. 1 is a front view of an installed folding grille assembly, in partial cut-away, mounted to close an opening in a narrow wall;

FIG. 2 is a cross-section taken along line 2-2 in FIG. 1;

FIG. 3 is a plan view of one panel of the grille;

FIG. 4 is a cross-section view taken along line 4-4 in FIG. 3;

FIG. 5 is a partial top view of the folding grille;

FIG. 6 is a partial front view of the folding grille showing one panel being inserted;

FIG. 7 is a cross-section detail view taken along line 7-7 in FIG. 6;

FIG. 8 is a cross-section taken along line 8-8 in FIG. 7;

FIG. 9 is a perspective view of the pocket employed in the assembly;

FIG. 10 is a detail perspective view taken at ‘A’ in FIG. 9;

FIG. 11 is a perspective view showing an adjustment means for the pocket;

FIG. 12 is a side view of the adjustment means; and

FIG. 13 is a cross section view of the grille within the pocket with pocket within the slot.

### DESCRIPTION OF THE PREFERRED EMBODIMENTS

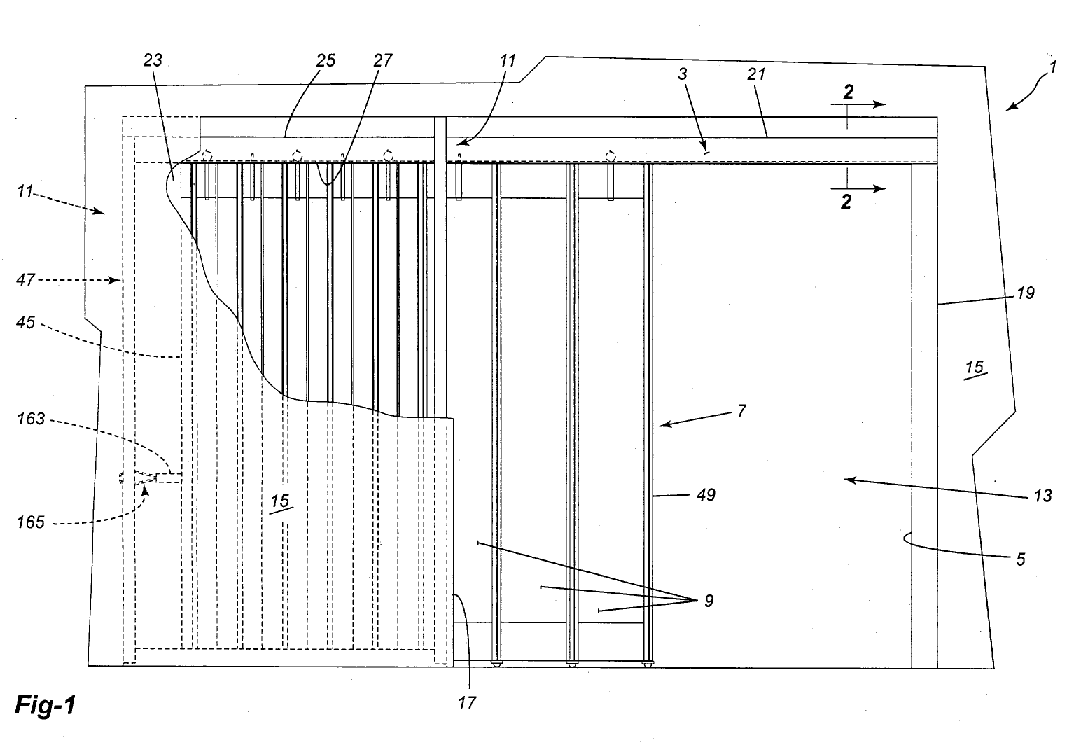

The folding grille assembly 1, as shown in FIG. 1, has a top rail 3; an end post 5; a folding grille 7 made up of a plurality of narrow panels 9; and a pocket 11. The grille assembly 1 is designed to close an opening 13 in a narrow wall 15, the opening defined by vertical sides 17, 19 and a top side 21. A slot 23 extends part way into the wall 15 from one side 17 of the opening 13, the slot 23 equal in height to the height of the opening 13.

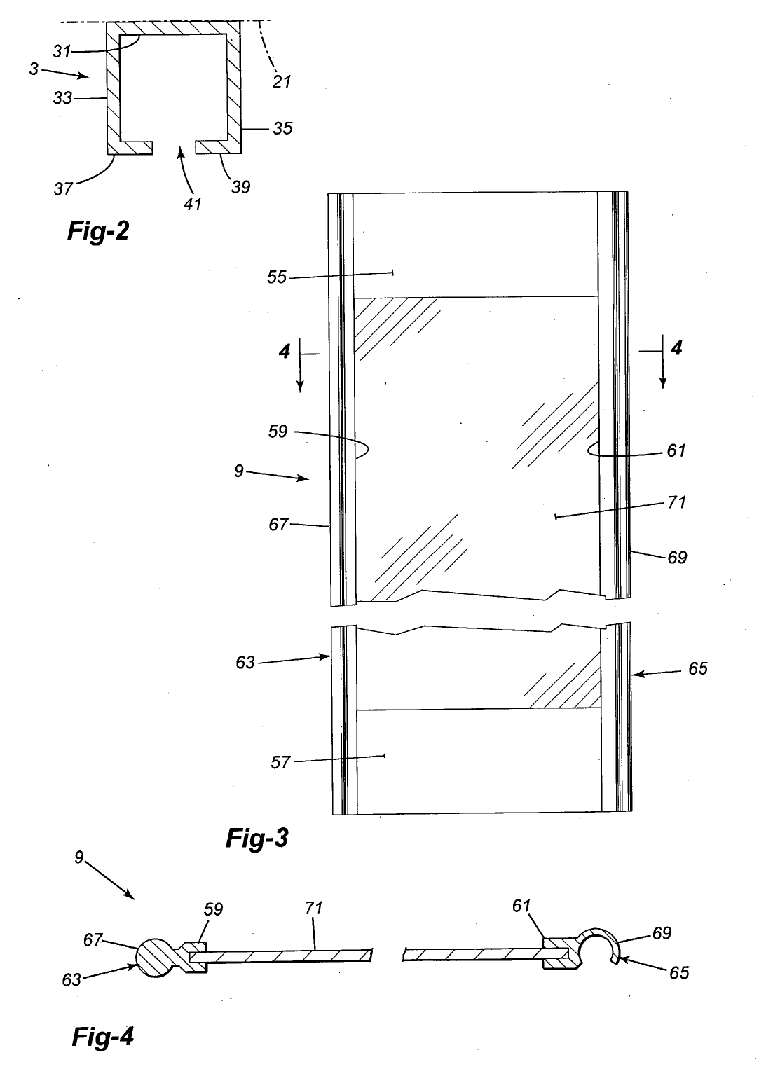

The pocket 11 of the grille assembly 1 is fixedly mounted to the wall 15 within the slot 23 adjacent the one side 17 of the opening 13 and forms part of the wall. The top rail 3 is fixedly mounted against the top side 21 of the opening 13, and the end post 5 is fixedly mounted against the other side 19 of the opening, opposite the slot 23. The top 25 of the pocket 11 has a top rail extension 27 which extension 27 forms a continuation of the top rail 3 when the pocket 11 is within the slot 23 and the top rail 3 is mounted against the top side 21 of the opening 13. The top rail 3 of the folding grille assembly is in the form of a straight channel having a top wall 31 as shown in FIG. 2. Side walls 33, 35 extend downwardly from the sides of the top wall 31, and short bottom walls 37, 39 extend inwardly toward each other from the bottom of the side walls 33, 35. A central, narrow, gap 41 is formed between the bottom walls 37, 39. The top rail extension 27 has the same cross-sectional shape as the top rail 3.

The folding grille 7 is movably suspended from the top rail 3 and the rail extension 27 with one end 45 of the grille 7 attached, by suitable means to be described, to the innermost or back end 47 of the pocket 11 within the slot 23. The grille 7 can be folded up and stored within the pocket 11 to fully open the opening 13. The grille 7 can be unfolded from the pocket 11 to extend fully across the opening 13 to close the opening, the other end 49 of the grille 7 connecting to the end post 5 to close the opening. The grille 7 travels across the rail extension 27 and the top rail 3 as it is unfolded to extend across the opening 13.

In accordance with the present invention ,the folding grille 7 and the pocket 11 of the grille assembly 1 are designed to allow the grille assembly to fit within a narrow wall to close an opening within the wall. The folding grille 7 is made up of narrow, vertical panels 9. Preferably, the panels are no wider than about four and one-half inches. Each vertical panel 9, as shown in FIGS. 3 and 4, has a top plate 55, a bottom plate 57 and side members 59, 61 joining the top and bottom plates 55, 57 together. One side member 59 carries a male hinge element 63 and the other side member 61 carries a female hinge element 65. The male hinge element 63 is in the form of a closed tube 67 while the female hinge element 65 is in the form of an open tube 69, the open tube 69 sized to snugly, rotatably, receive the closed tube 67. If desired, a transparent or opaque panel 71 can be mounted between the top and bottom plates 55, 57 and the side members 59, 61.

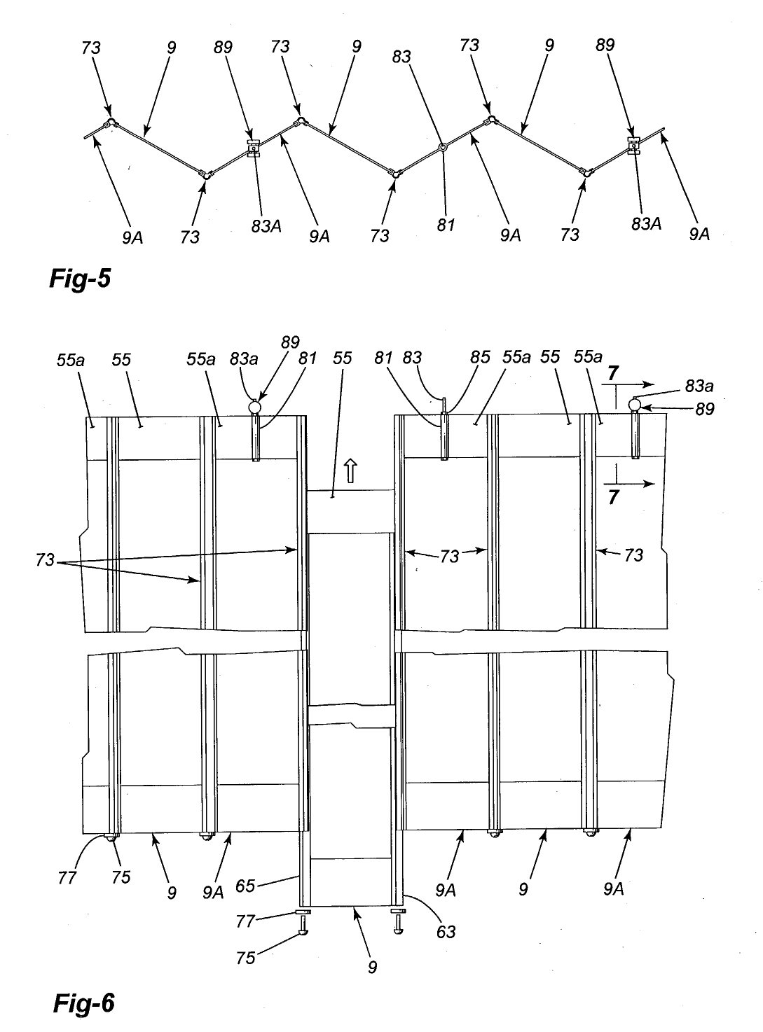

The panels 9 are hingedly connected together, as shown in FIGS. 5 and 6, by connecting the female hinge element 65 on each panel to the male hinge element 63 on an adjacent panel to form hinges 73. The closed tube 67 on the male hinge 63 is passed through the open tube 69 on the female hinge 65. A screw 75 can be inserted into the bottom of the closed tube 67 of the male hinge 63 with a washer 77 to support the bottom of the open tube 69 of the female hinge 65.

Suspension means are provided for mounting the grille 7 from the top rail 3. In accordance with the present invention, the suspension means includes having every second panel 9A in the grille with its top plate 55 formed with a central, vertical, tubular section 81. A mounting bolt 83 passes upwardly through the section 81, the head 84 of the bolt 83 abutting on the bottom of the top plate 55. A fastener, such as a nut 85, is threaded onto the bolt 83 to abut onto the top of the top plate 55 to lock the bolt 83 to the top plate 55.

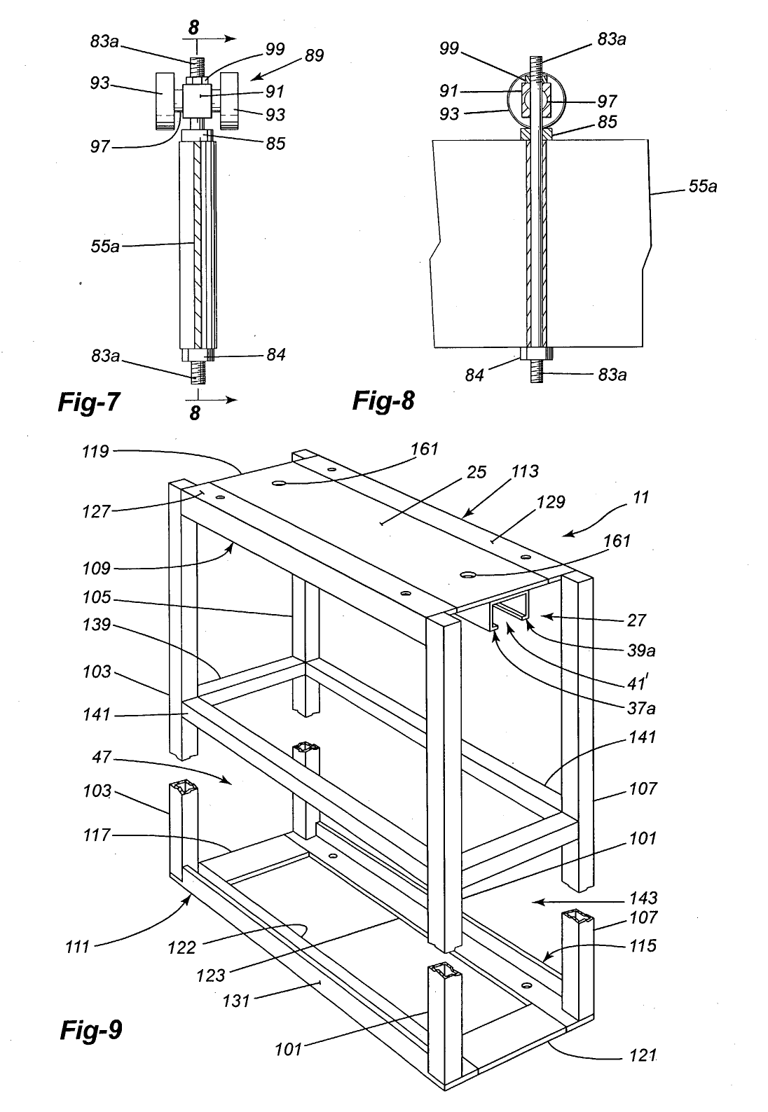

A trolley 89 is mounted on the top of every second bolt 83a in the grille as shown in FIG. 6. Each trolley 89 has a main body 91 with wheels 93 on each side of the body 91 as shown in FIGS. 7 and 8. The main body 91 has a central opening 95 through which the bolt 83a passes, the bolt also passing through the axle 97 of the wheels 73. A nut 99 on the top of the bolt 83a abuts the top of the body 91. The trolley 89 is rotatable on the bolt 83a and, with the bolt 83a, forms part of the suspension means. Every other bolt 83, without a trolley 89 thereon, acts as a guide member as will be described.

The pocket 11 forms a receptacle for the folded grille 7 and is mounted in the slot 23 extending inwardly from the one side edge 17 of the main opening 13. The pocket 11 is defined by a set of at least four, parallel, vertical, square tubes 101, 103, 105 and 107, the tubes arranged at the corners of a tall space having a narrow, rectangular cross-section. The first and second corner tubes 101, 103, together with top and bottom angle cross members 109, 111, form one wide side of the pocket; and the third and fourth corner tubes 105, 107, together with top and bottom angle cross members 113, 115 form the other wide side of the pocket, parallel to the first wide side. The second and third corner tubes 103, 105, together with a bottom, back, cross plate 117 and a top plate 119 joining the top angle members 109, 113, form the narrow back 47 of the pocket. The first and fourth corner tubes 101, 107, together with a bottom front cross plate 121 and the top plate 119 form the narrow front of the pocket. The bottom cross plates 117, 121 are welded to the inner edges of the horizontal flanges 122, 123 of the bottom angle members 111, 115 respectively. The top angle cross members 109, 113 are joined by the central top plate 119 welded to the inner, horizontal flanges 127, 129 of the top cross members 109, 113 respectively.

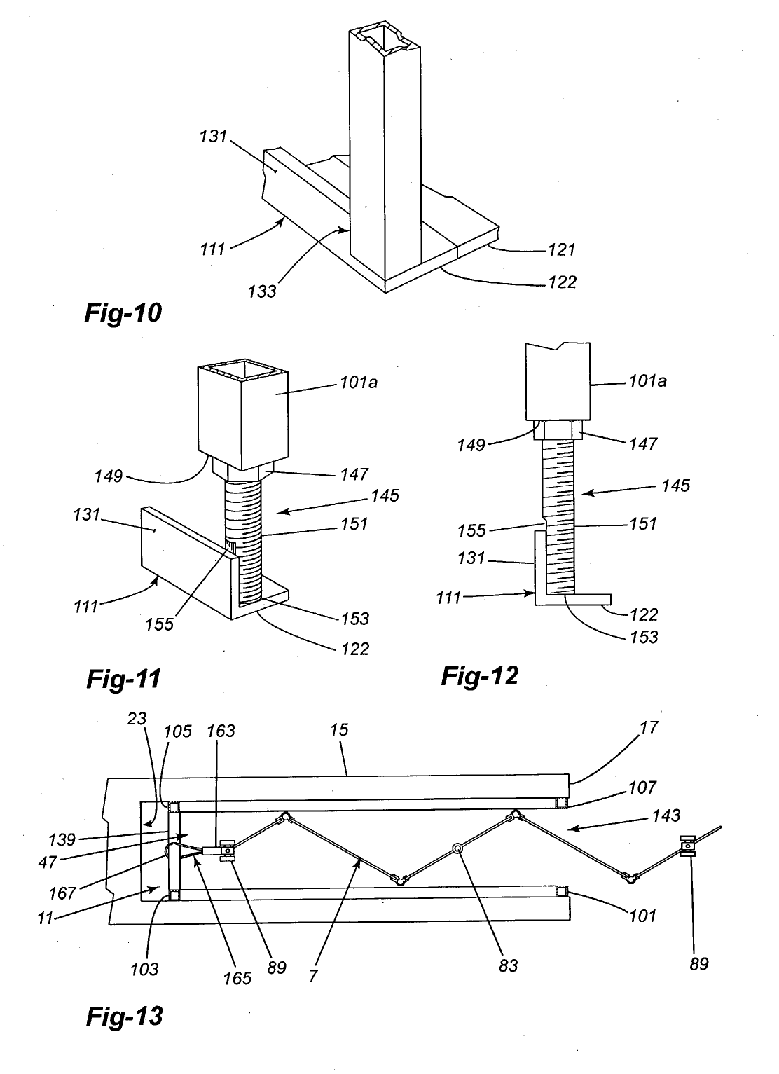

The top cross members 109, 113 and the central top plate 119 lie between the front corner tubes 101, 107 and the back corner tubes 103, 105. The bottom angle cross members 111, 115 are slightly longer than the top angle cross members 109, 113 and extend under the tubes and are attached to them by welding. More specifically, each bottom angle member 111, 115 is cut away at the corners of their outer vertical flanges 131, as shown at 133 at one corner in FIG. 10. Each corner tube, such as tube 101, is welded to the horizontal flange 122 and to the side 135 of the cutouts 133 on the vertical flange 131. Horizontal cross-tubes 139, 141 can be used to strengthen the pocket intermediate the top and bottom of the vertical tubes, the cross-tubes 139 employed on the narrow back 47 and the cross tubes 141 employed on the wide sides of the pocket. The front 143 of the pocket is left open forming the entrance into the pocket. It will be seen that the outer periphery of the pocket is defined by the corner tubes with the connecting angle members; cross members; and cross tubes all located within the space defined by the corner tubes.

Preferably, adjustment means 145 can be provided at the bottom of each of the vertical tubes 101, 103, 105, 107 to adjust the height of the pocket during installation and to level it. The adjustment means 145 on the vertical tubes are identical with the tubes being shortened slightly to accommodate the adjustment means. The adjustment means 145 on shortened tube 101a, as shown in FIGS. 11 and 12, comprises a nut 147 welded to the bottom 149 of the tube 101a. A threaded rod 151 is threaded into the nut 147. Once the bottom 153 of the rod 151 is at the right height, its bottom, outer side 155 is ground flat so it is flush against the vertical side flange 131 of the bottom angle member 111 when it rests on the bottom flange 122 of the angle member 111. The rod 151 is then fixed to the bottom angle member 111 by welding the flat side 155 against the vertical flange 131 and its bottom end 153 against the horizontal flange 122. It will be seen that in using the adjusting means 145, the pocket 11 is temporarily assembled within the slot and the adjustment means are used to level the pocket within the slot. Once level, the pocket 11 is removed from the slot and the bottom of the pocket is welded to the adjustment rods 151 to permanently assembly the pocket. The permanently assembled pocket 11 is then permanently mounted in the slot, the pocket being level in the slot when mounted therein so that the grille, when suspended within the pocket, hangs straight.

The top rail extension 25 is mounted on the bottom of the top center plate 119 of the pocket 11 by suitable fasteners 161, the rail extension 25 identical in cross-section to the top rail 3, and aligned with it when the pocket 11 is mounted within the wall.

To install the grille assembly, the pocket 11 is securely mounted within the slot 23 by passing fasteners (not shown) upwardly through the horizontal flanges 127, 129 of the top angle members 109, 113 into wall support members (not shown) that define the top of the slot; and through the horizontal flanges 122, 123 of the bottom angle members 111, 113 into the floor. The grille 7 can then be mounted on the rail extension 25 by the trolleys 89, the trolleys riding on the bottom walls 37a, 39a of the rail extension 25. the rods 83a on the trolleys extend through the gap 41′ on the rail extension as do the rods 83 without trolleys. The bottom walls of the rail extension serve to guide the rods between them thus guiding the grille. The grille 7 is folded within the pocket 11 with the inner end 45 of the grille, which could comprise a post member 163 connected by a hinge to the first panel 9 as shown in FIG. 13. The post member 163 is connected to the back 47 of the pocket 11 by suitable connecting means 165. The connecting means 165 can comprise a length of chain 167 looped about the post member 163 and a back cross member 139. The chain 167 is fastened to itself to hold the end of the grille within the pocket closely adjacent to the back of the pocket. While one type of connecting means has been described, other types of connecting means can be employed.

Once the grille 7 is installed within the pocket 11, the top rail 3 can be attached to the top 21 of the opening 13 aligned with the rail extension 25 and the end post 5 can be mounted on the other side 19 of the opening 13. The grille 7 can then be unfolded out of the pocket 11 with its trolleys 89 riding on the top rail 3 to extend across the opening 13 to the end post 5 and fastened thereto to close the opening. The rods 83, 83a on the grille 7 are guided in the gap 41 in the top rail 3 to guide the grille in moving across the top rail.

While the pocket has been described as having four vertical square tubes as corner posts it could have more posts, the extra posts in the sides of the pocket, intermediate the corner posts.

The pocket has been described as being inserted into a slot formed in the wall adjacent one side of the opening. The pocket could however be mounted in the opening adjacent one side thereof, the pocket aligned and centered with respect to the wall and forming an extension of the wall. Once the pocket has been so mounted and the grille installed, the pocket can be enclosed with wallboard or the like to have it conform to the wall in thickness and appearance and to form part of the wall.

I claim:

1. A folding grille having a plurality of narrow, vertical, panels, the panels hingedly joined together in serial fashion by vertical hinges, every second panel only carrying a vertical mounting rod at its top end extending up from the top, center of the panel, and every second mounting rod only carrying a trolley by means of which the grille can be supported.

2. A folding grille as claimed in claim 1 wherein the panels are no wider than about four and one-half inches to allow the grille to fold into a narrow space.

3. A folding grille as claimed in claim 1 including stop means on the hinges to have the panels form an angle between adjacent panels that is no greater than 140° when the grille is unfolded.

4. A folding grille as claimed in claim 1 wherein each panel has a top plate, every second panel having its top plate formed with a central, vertical, tubular section through which the mounting rod is mounted.

5. A folding grille as claimed in claim 2 including stop means on the hinges to have the panels form an angle between adjacent panels that is no greater than 140° when the grille is unfolded.

6. A folding grille assembly for use in closing an opening in a narrow wall, the opening having a top and sides, the grill assembly having: a pocket adapted to be mounted on one side of the opening, the pocket aligned with the wall and forming a part of the wall; and a folding grille, the grille having a plurality of narrow, vertical, panels, the panels hingedly joined together in serial fashion by vertical hinges, every second panel only carrying a vertical mounting rod at its top end extending up from the top, center of the panel, and every second mounting rod only carrying a trolley by means of which the grille can be movably supported at the top of the opening, the pocket forming a receptacle for the grille when the grille is folded to open the opening.

7. A grille assembly as claimed in claim 6 including a top rail for mounting on the top of the opening, the trolleys on the top of the grille supported by the top rail to movably support the grille from the top rail.

8. A grille assembly as claimed in claim 7 wherein the top rail is an inverted channel having bottom walls extending inwardly toward each other, the bottom walls defining a narrow gap between them, the mounting rods extending into the rail through the gap to have the bottom walls guide the rods and thus the grille, the trolleys on the rods riding on the bottom walls.

9. A grille assembly as claimed in claim 7 including a top rail extension on the top of the pocket, the rail extension aligned with the top rail when the pocket is mounted in the slot to movably support the grille when it is folded into the pocket.

10. A grille assembly as claimed in claim 6 wherein the pocket is formed from four vertical square tubes located at the corners of the pocket, the tubes enclosing a narrow space having a rectangular cross-section.

11. A grille assembly as claimed in claim 10 including adjustment means on the bottom of each tube for use in leveling the pocket within the slot.

12. A grille assembly as claimed in claim 10 wherein the pocket has two wide sides, a narrow back and a narrow front; the front being open for receiving the grille within the pocket, the other two sides and the back of the pocket having cross members connecting the vertical tubes together to strengthen the pocket.

13. A grille assembly as claimed in claim 12 including adjustable attaching means for attaching one end of the grille to the back of the pocket.

14. A grille assembly as claimed in claim 13 wherein the adjustable attaching means comprises a chain that has a hook at one end for connecting the chain to itself after the chain is looped about an end post on the grille and the back of the pocket.

15. A grille assembly as claimed in claim 6 wherein the panels are no wider than about four and one-half inches to allow the grille to fold into a narrow space.

16. A grille assembly as claimed in claim 6 including stop means on the hinges to have the panels form an angle between adjacent panels that is no greater than 140° when the grille is unfolded.

17. A grille assembly as claimed in claim 6 wherein each panel has a top plate, every second panel having its top plate formed with a central, vertical tubular section through which the mounting rod is mounted.

18. A grille assembly as claimed in claim 16 including stop means on the hinges to have the panels form an angle between adjacent panels that is no greater than 140° when the grille is unfolded.

19. A pocket for use with a rolling grille for closing an opening in a wall, the pocket adapted to be mounted on one side of the opening and forming a part of the wall, the pocket having four vertical square tubes located at the corners of the pocket, connecting members at the top and bottom of the tubes to connect the tubes into a rigid structure, the tubes enclosing a narrow space having a rectangular cross-section, the connecting members within the space defined by the tubes.

20. A pocket as claimed in claim 19 including one-time adjustment means on the bottom of each tube for leveling the pocket within the slot.

21. A pocket as claimed in claim 20 wherein the adjustment means include a nut fixed to the bottom of each tube, and a threaded rod inserted into the post through the nut, each rod adjusted to level the pocket, and each rod then fixed to the connecting members at the bottom of the pocket.

22. A pocket as claimed in claim 19 wherein the pocket has two wide sides, a narrow back and a narrow front; the front being open for receiving the grille within the pocket, the other two sides and back of the pocket having cross members intermediate the top and bottom of the tubes connecting the vertical tubes together to strengthen the pocket.

23. A pocket as claimed in claim 22 including a rail extension fastened to the underside of the top connecting members.
